(19) United States
(12) Patent Application Publication
(10) Pub. No.: US 2006/0164366 A1
(43) Pub. Date: Jul. 27, 2006

(54) Circuits and methods for synchronizing multi-phase converter with display signal of LCD device

(75) Inventors: Chung-Che Yu, Taipei (TW); Wen-Chieh Chiang, Taipei (TW); Li-Min Lee, Taipei (TW)

Correspondence Address: Hart, Baxley, Daniels & Holton, Third Floor, 90 John Street, New York, NY, 10038, US

(73) Assignee: Beyond Innovation Technology Co., Ltd.

(21) Appl. No.: 11/042,303

(22) Filed: Jan. 24, 2005

(51) Int. Cl. G09G 3/36

(52) U.S. Cl. 345/98

(57) ABSTRACT

A controller for controlling at least two power circuits comprises a synchronous oscillator and a multi-phase PWM controller. The synchronous oscillator receives a timing signal for generating a synchronous control signal in which the timing signal is synchronous to a display signal. The multi-phase PWM controller receives the synchronous control signal for generating at least two PWM signals. The at least two PWM signals are coupled to the at least two power circuits for driving the at least two power circuits respectively. The at least two PWM signals are synchronous to the timing signal and with a phase shift between the at least two PWM signals.

### BACKGROUND OF THE PRESENT INVENTION

1. Field of Invention

The present invention relates to a converter driving circuit for supplying energy to multiple loads, such as a LCD device including a gate driver, a source driver, a gamma voltage generator, and a timing controller, and more particularly to a multi-phase converter driving circuit which is adapted to synchronize the multi-phase converter with a Display signal. Usually, the converters are applied to display devices, such as liquid crystal display monitors, liquid crystal display computers or liquid crystal display televisions.

2. Description of Related Arts

Liquid crystal displays (LCD) are wildly employed in display devices, such as liquid crystal display monitors, liquid crystal display computers or liquid crystal display televisions. A driving circuit of a related art LCD device is described in U.S. Pat. No. 6,731,259. As shown in FIG. 1, which is a block diagram of a related art LCD device, the related art LCD device includes a LCD panel 101, a gate driver 102, a source driver 103, a gamma voltage generator 104, and a timing controller 105. In the LCD panel 101, a plurality of gate lines are arranged to cross a plurality of data lines. A TFT and a pixel electrode are arranged at each crossing portion of the gate and data lines. The gate driver 12 sequentially applies a driving signal to the gate lines. The source driver 103 applies a data signal to the data lines. The gamma voltage generator 104 applies a reference voltage to the source driver 103. The timing controller 105 applies various control signals and voltages to the gate driver 102 and the source driver 103.

In the aforementioned LCD device, light irradiated from a back light (not shown) passes through each of R (red), G (green), and B (blue) color filters in accordance with a voltage applied to each pixel electrode of the LCD panel 101, thereby displaying picture images.

To maintain a stable display quality of the LCD device, an exact and uniform gamma voltage is required. The gamma voltage is generated by a resistance string having a plurality of serially arranged resistors. The gamma voltage is divided to adapt to the transmittivity characteristic of the liquid crystal panel and to obtain a required gray level.

As shown in FIG. 2, the source driver includes a shift register 201, a sampling latch 202, a holding latch 203, a digital to analog (D/A) converter 204, and an amplifier 205. The shift register 201 shifts a horizontal synchronizing signal through a source pulse clock HCLK and outputs a latch clock to the sampling latch 202. The sampling latch 202 samples the R, G, and B digital data for each column line (data line) in accordance with the latch clock output from the shift register 201, and then latches the sampled R, G, and B data. The holding latch 203 latches the R, G, and B data latched by the sampling latch 202 through a load signal LD. The D/A converter 204 converts the R, G, and B digital data latched by the holding latch 203 to analog signals. The amplifier 205 amplifies the R, G, and B data converted to analog signals at a certain width and outputs the amplified R, G, and B data to each data line of the LCD panel. The source driver 103 samples and holds the R, G, and B digital data during 1 horizontal period, converts them to analog data, and amplifies the converted analog data at a certain width. If the holding latch 203 holds the R, G, and B data to be applied to nth data line, the sampling latch 202 samples the R, G, and B data to be applied to (n+1) data line. The operation of the aforementioned related art driving circuit of the LCD device will be described below.

A video card (not shown) outputs R, G, and B digital data output to input to the source driver 103 without processing. The source driver 103, controlled by the timing controller 105, converts the R, G, and B digital data to analog signals that can be applied to the LCD panel 101, and outputs the resultant values to each data line. At this time, the gamma voltages obtained by voltage division through resistors are output from the gamma voltage generator 104 to the source driver 103. The gamma voltages are varied depending on the LCD module.

If the gamma voltages are input to the source driver 103, the same voltage is applied to each of R, G, and B pixel electrodes, and the liquid crystal is driven depending on the applied voltage to obtain corresponding brightness of light.

Such conventional applications require direct current/direct current converters (DC/DC converters) to supply reference voltages to Liquid crystal displays, the timing controller, a gamma voltage generator, a gate drive IC (Integrated Circuit), a source drive IC including a shift register, a sampling latch, a holding latch, a digital to analog (D/A) converter, and an amplifier.

When the D/A converter converts the R, G, and B digital data latched by the holding latch to analog signals, the quality of the displaying picture images will be affected if the reference voltages or the gamma voltages are varied depending on current ripples and noises caused by turning ON and turning OFF switches in the DC/DC converter. And Image quality will also be affected when the sample hold (S/H) circuit is sampling or common electrode driving signal (V_{COM}) is generating. In other words, the quality of the displaying picture images will be affected by current ripples and noises caused by turning ON and turning OFF switches in the DC/DC converter. Therefore, the critical factors in the design of a DC/DC converter include efficiency, cost, size, and more particularly to high current ripples and noises caused by turning ON and turning OFF switches in the DC/DC converter. What this implies is that the need for a better quality converter never stops. As a matter of fact, almost all converters which are capable of converting a direct current power into a direct current power involve certain high current ripples and noises caused by turning ON and turning OFF switches in the DC/DC converter. The key question becomes how to minimize such disturbance on the power line caused by high current ripples and noises caused by turning ON and turning OFF switches in the DC/DC converter, while at the same time keeping the conversion process efficient and economical.

Referring to FIG. 3 of the drawings, FIG. 3 shows a conventional DC/DC converter circuitry. The DC/DC converter circuitry 300 comprises a buck converter 301, and a controller 302. The buck converter 301 is coupled to the controller 302. The controller 302 provides a control signal to drive the buck converter 301. Therefore, an output voltage of the buck converter 301 is controlled by turning ON and turning OFF switches in the buck converter 301. In other words, in the buck converter 301 with a given input voltage, the average output voltage of the buck converter 301 is controlled by controlling the switches on and off durations. The controller 302 further comprises a oscillator 331, a pulse-width modulation (PWM) generator 332, a feedback controller 333, and an output driver 334. The oscillator 331 in the controller 302 generates a string of clock signals to the PWM generator 332. An output circuit 325 is coupled to the buck converter 301 and to be a load of the buck converter 301. An output characteristic of the output circuit 325 is measured from the sensor circuit 326. The sensor circuit 326 comprises two resistors to detect the output characteristic. The feedback controller 333 is coupled to the sensor circuit 326 and delivers feedback control signals to the PWM generator 332. The PWM generator 332 receives feedback control signals and clock signals and delivers PWM signals to the output driver 334. The frequency of clock signals determines the switching frequency of the converter. Finally, the output driver 334 delivers control signals to drive and control the switches on and off durations in the buck converter 301. Hence the average output voltage of the buck converter 301 could be controlled by controlling the switches on and off durations.

The buck converter 301 comprises a switch 321, a diode 322, an inductor 323, and a capacitor 324. The switch 321 is in series with the DC input V_{dc}. It controls the “on” duration of switch 321 to obtain an average output voltage Vₒᵤₜ=V_{dc}Tₒₙ/T. The inductor 323 and a capacitor 324 act as a filter and are added in series between the switch 321 and output circuit 325 to yield a clean voltage at output circuit 325. Therefore, there is a large ripple on the power line. The simultaneous turning on and off at the buck converter 301 cause noises on the power line which degrades the signal/noise integrity in the system.

The above example uses a buck converter to illustrate the conventional DC/DC converter circuitry. Nevertheless, the DC/DC converter circuitry 300 could use a boost converter, a push-pull converter, a forward converter, a flyback converter, a half-bridge converter, or a full-bridge converter instead of the buck converter.

One method to reduce the ripple is to increase the filtering at the power line. However, the disadvantage is that the size of the circuit is increased, which in turn increases the system cost.

There are disadvantages regarding this conventional DC/DC converter circuitry for supplying energy to the LCD device. However, the switching frequency of the DC/DC converter is asynchronous to the frequency of the D/A converter converting the R, G, and B digital data latched by the holding latch to analog signals. As a result, when the DC/DC converter circuitry is utilized in practice for supplying energy to the LCD device, an interference (or moire) phenomenon in the horizontal or vertical direction of the display results from the difference frequency between the switching frequency and the frequency.

### SUMMARY OF THE PRESENT INVENTION

A main object of the present invention is to provide a controller for controlling at least two DC/DC converters, wherein the DC/DC converters supply energy to multiple loads, such as a LCD device including a gate driver, a source driver, a gamma voltage generator, and a timing controller, which is adapted to synchronize the converters with a display signal so as to substantially eliminate an interference (or moire) phenomenon in the horizontal or vertical direction of the display resulted from the difference frequency between the frequency of the display signal and the switching frequency of the DC/DC converter.

Another object of the present invention is to provide a multi-phase converter driving circuit for supplying energy to multiple loads, such as a LCD device including a gate driver, a source driver, a gamma voltage generator, and a timing controller, which is adapted to synchronize the multi-phase converter with a display signal so as to substantially eliminate an interference (or moire) phenomenon in the horizontal or vertical direction of the display resulted from the difference frequency between the frequency of the display signal and the switching frequency of the DC/DC converter.

Another object of the present invention is to a multi-phase converter driving circuit for supplying energy to multiple loads, such as a LCD device including a gate driver, a source driver, a gamma voltage generator, and a timing controller, which reduces instantaneous high current ripples and noises caused by controlling the switches on and off durations in the multi-phase converter driving circuit.

Another object of the present invention is to provide a display device which utilizes a multi-phase converter driving circuit for supplying energy to multiple loads, such as a LCD device including a gate driver, a source driver, a gamma voltage generator, and a timing controller, which is adapted to synchronize the multi-phase converter with a display signal so as to substantially eliminate an interference (or moire) phenomenon in the horizontal or vertical direction of the display resulted from the difference frequency between the frequency of the display signal and the converter switching frequency.

Accordingly, in order to accomplish the above objects, the present invention provides a controller for controlling at least two power circuits, comprising:

a synchronous oscillator receiving a timing signal for generating a synchronous control signal which is synchronous to said timing signal, wherein said timing signal is substantially synchronous to a display signal; and

a multi-phase PWM controller receiving said synchronous control signal for generating at least two PWM signals, wherein said at least two PWM signals are coupled to said at least two power circuits for driving said at least two power circuits respectively and said at least two PWM signals are synchronous to said display signal and with a phase shift between said at least two PWM signals.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a related art driving circuit of a LCD device.

FIG. 2 is a schematic view of a source driver of FIG. 2.

FIG. 3 is a conventional DC/DC converter circuitry.

FIG. 4 a schematic view of DC/DC converter circuitry according to a preferred embodiment of the present invention.

FIG. 5 is waveforms of the first PWM signals, the second PWM signals, the synchronous control signals, and feedback control signals according to the above preferred embodiment of the present invention.

FIG. 6 is waveforms of Horizontal synchronization (HSYNC) signals, the frequency doubling signals with respect to the HSYNC signals, the frequency dividing signals with respect to the HSYNC signals, the vertical synchronization (VSYNC) signals, the frequency doubling signals with respect to the VSYNC signals, and the frequency dividing signals with respect to the VSYNC signals according to the above preferred embodiment of the present invention.

FIG. 7 is a circuit diagram of a synchronous oscillator according to the above preferred embodiment of the present invention.

FIG. 8 is an alternative circuit diagram of a synchronous oscillator according to the above preferred embodiment of the present invention.

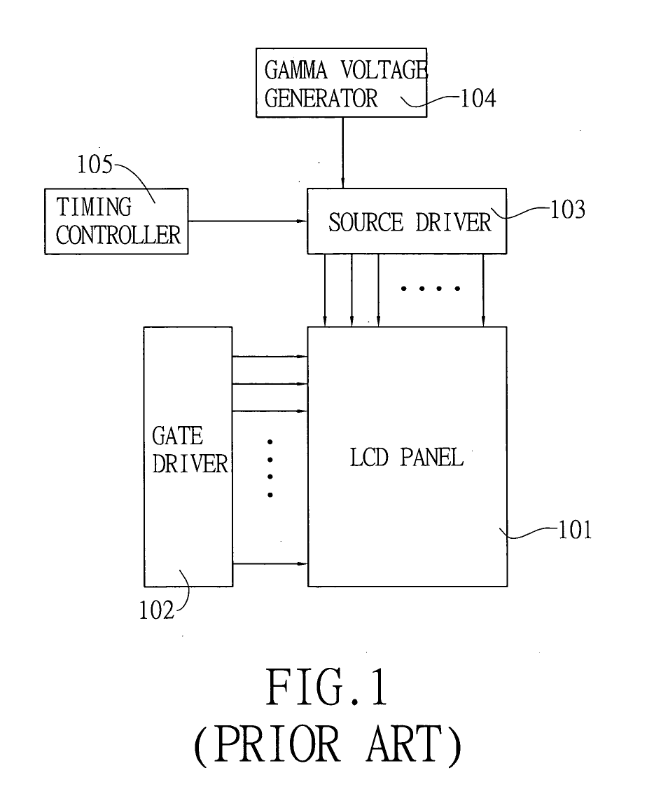

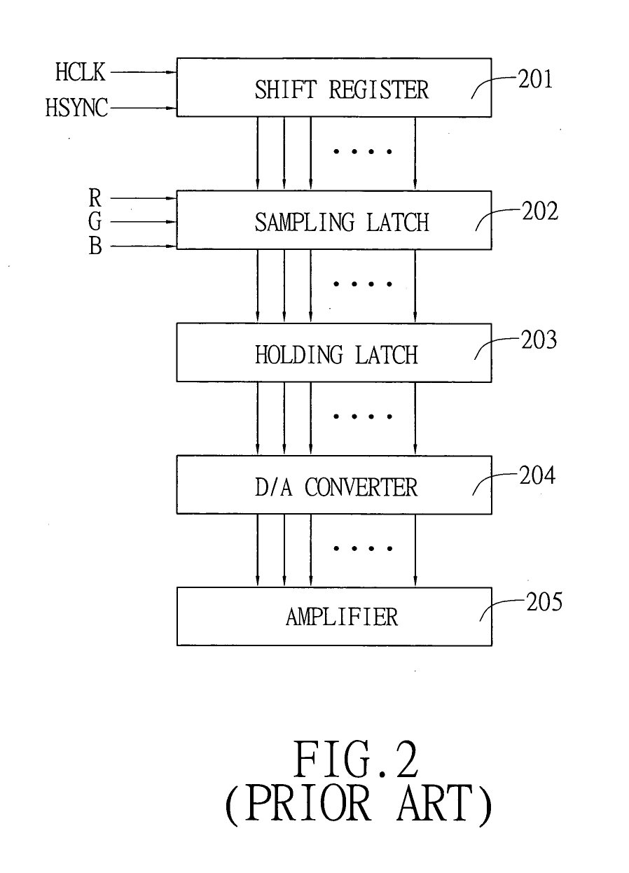

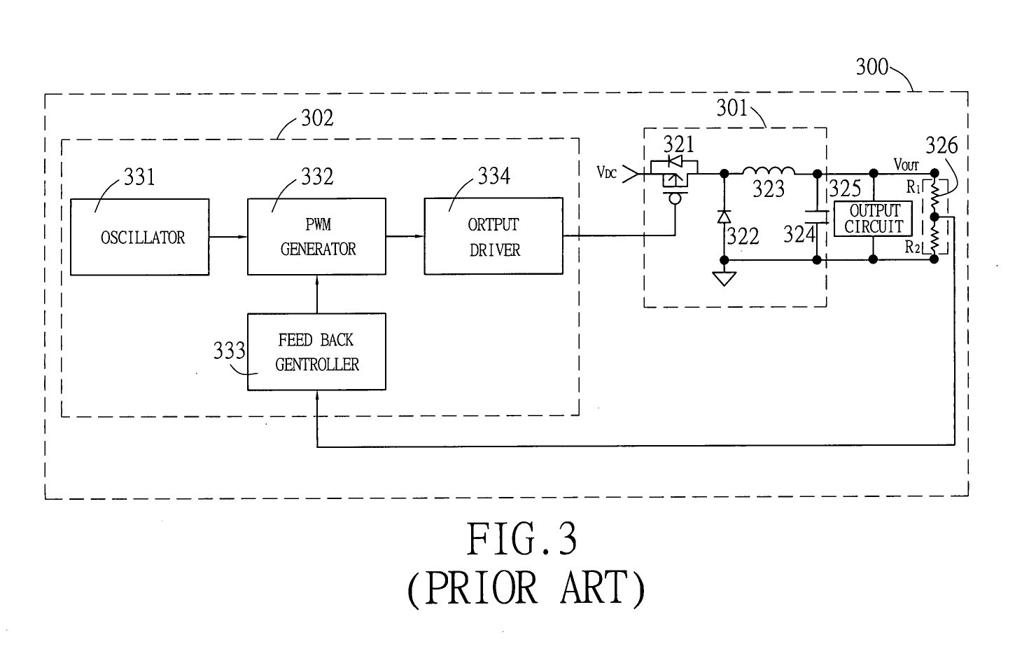

### DETAILED DESCRIPTION OF THE PREFERRED EMBODIMENT

The following examples use a buck converter to illustrate the embodiments of the invention. Nevertheless, the DC/DC converter of this invention is not limited to a buck converter. However, the DC/DC converter circuitry could use a boost converter, a push-pull converter, a forward converter, a flyback converter, a half-bridge converter, or a full-bridge converter instead of the buck converter.

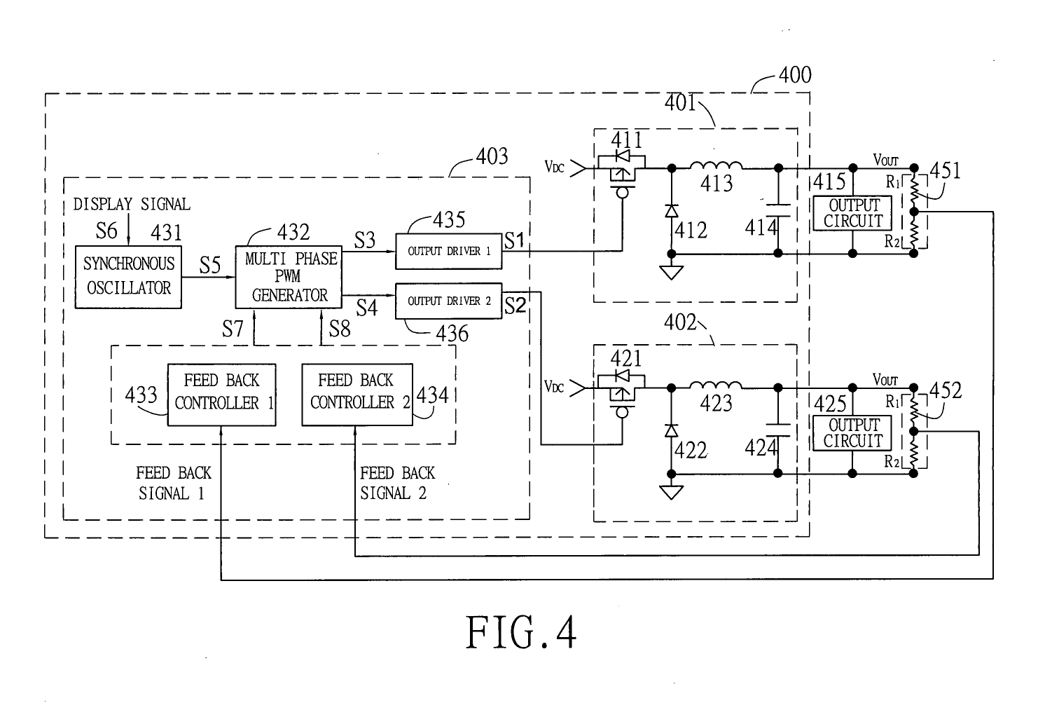

Referring to FIG. 4 of the drawings, a schematic view of DC/DC converter circuitry according to a preferred embodiment of the present invention is illustrated. All output circuits 415, 425 are synchronized. The DC/DC converter circuitry 400 comprises a first DC/DC converter 401, a second DC/DC converter 402, and a controller 403. In this embodiment, the first DC/DC converter 401 and the second DC/DC converter 402 are buck converters. The first DC/DC converter 401 and the second DC/DC converter 402 are coupled to the controller 403. The controller 403 provides control signals S1, S2 to drive the first DC/DC converter 401 and the second DC/DC converter 402 respectively. Therefore, output voltages of the first DC/DC converter 401 and the second DC/DC converter 402 are respectively controlled by turning ON and turning OFF switches in the DC/DC converters. In other words, in the first DC/DC converter 401 and the second DC/DC converter 402 with a given input voltage, the average output voltages of the first DC/DC converter 401 and the second DC/DC converter 402 are controlled by controlling the switches on and off durations. The controller 403 further comprises a synchronous oscillator 431, a multi-phase pulse-width modulation (PWM) generator 432, a first feedback controller 433, a second feedback controller 434, a first output driver 435, and a second output driver 436. The synchronous oscillator 431 receives a timing signal S6 and then generates a sawtooth ramp of synchronous control signals S5. The timing signal S6 is synchronous to a display signal. The display signal could be a Horizontal synchronization (HSYNC) signal, a frequency doubling signal with respect to the HSYNC signal, a frequency dividing signal with respect to the HSYNC signal, an output control signal for a source driver, a source driver start pulse, and a gate driver shift clock. In addition, the display signal could be a vertical synchronization (VSYNC) signal, a frequency doubling signals with respect to the VSYNC signal, and a frequency dividing signal with respect to the VSYNC signal.

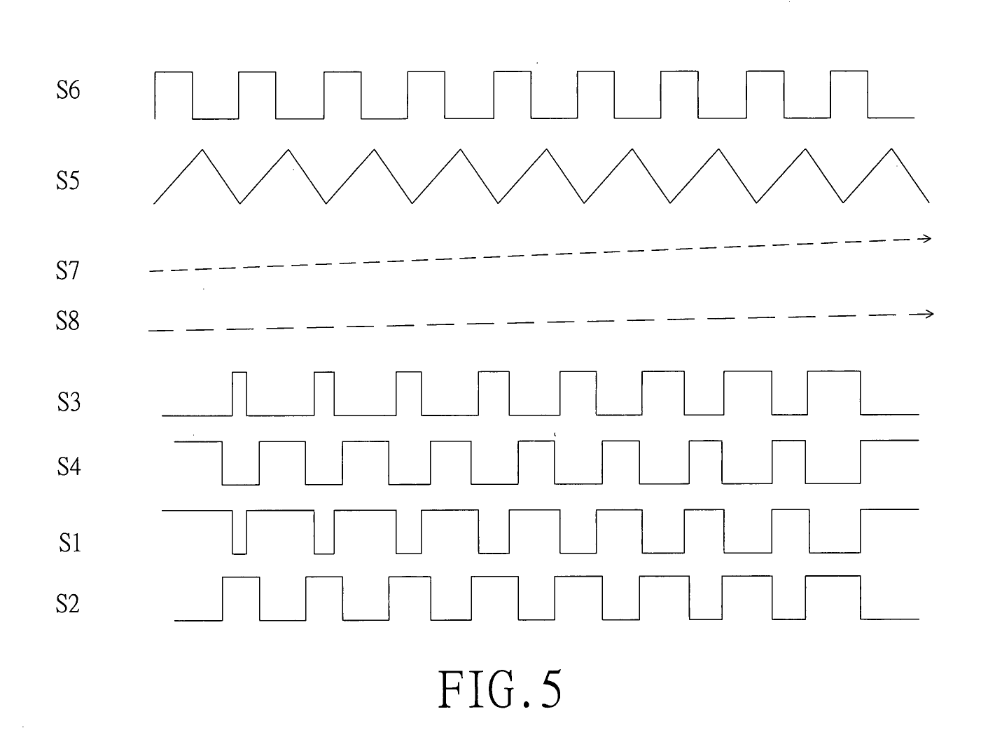

Referring to FIG. 5 of the drawings, waveforms of the timing signal S6, the synchronous control signals S5, the first feedback control signal S7, the second feedback control signal S8, the first PWM signals S3, the second PWM signals S4, the first control signal S1 and the second control signal S2 according to the above preferred embodiment of the present invention.

An output circuit 415 is coupled to the buck converter 401 and to be a load of the buck converter 401. And an output circuit 425 is coupled to the buck converter 402 and to be a load of the buck converter 402. The output characteristic of each output circuits 415, 425 is measured from the sensor circuit 451, 452 respectively. Both sensor circuit 451 and sensor circuit 452 comprise two resistors to detect their output characteristic. The first feedback controller 433 is coupled to the first sensor circuit 451 and delivers feedback control signals S7 to the multi-phase PWM generator 432. The second feedback controller 434 is coupled to the second sensor circuit 452 and also delivers feedback control signals S8 to the multi-phase PWM generator 432. The frequency of synchronous control signals determines the switching frequency the converter. The multi-phase PWM generator 432 receives the synchronous control signals S5, feedback control signals S7, and feedback control signals S8 and then generates first PWM signals S3 and second PWM signals S4. The first PWM signals S3 and the second PWM signals S4 have the same switching frequency but their phases are different. Hence the first PWM signals S3 and the second PWM signals S4 are synchronous to the timing signal and are with a phase shift between the two PWM signals. Finally, the first output driver 435 receives the first PWM signals S3 and delivers control signals S1 to drive and control the switches on and off durations in the first DC/DC converter 401. In the same reason, the second output driver 436 receives the second PWM signals S4 and delivers control signals S2 to drive and control the switches on and off durations in the second DC/DC converter 402. Hence the average output voltages of the first DC/DC converter 401 and the second DC/DC converter 402 could be controlled by controlling the switches on and off durations with a phase shift between the first DC/DC converter 401 and the second DC/DC converter 402.

All output circuits 421, 422 are synchronized. Since the switches in the first DC/DC converter 401 and the second DC/DC converter 402 are turned on and off with a phase shift between the two converters. Therefore, the ripples and noises on the power line are effectively reduced. In addition, the interference (or moire) phenomenon in the horizontal or vertical direction of the display device could be effectively eliminated because the switching frequencies in the first DC/DC converter 401 and the second DC/DC converter 402 are synchronous to the frequency.

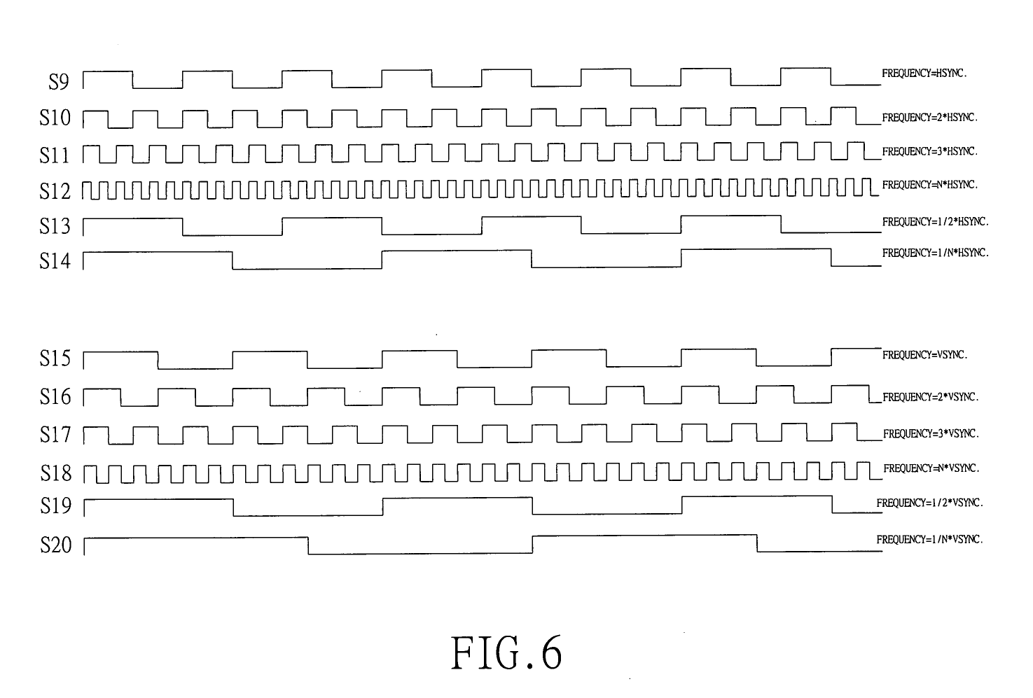

Referring to FIG. 6 of the drawings, it is illustrated that waveforms of Horizontal synchronization (HSYNC) signal, the frequency doubling signal with respect to the HSYNC signal, the frequency dividing signal with respect to the HSYNC signal, the vertical synchronization (VSYNC) signal, the frequency doubling signal with respect to the VSYNC signal, and the frequency dividing signal with respect to the VSYNC signal according to the above preferred embodiment of the present invention. In the embodiment, the timing signal S6 could be the Horizontal synchronization (HSYNC) signal S9, the frequency doubling signal S10 with respect to the Horizontal synchronization (HSYNC) signal. It should be noted that it is possible to extend the invention to generate the timing signal S6 whose frequency is a larger multiple of the HSYNC signal than two. Therefore, the timing signal S6 could be the frequency tripling signal S11 with respect to the Horizontal synchronization (HSYNC) signal, the frequency signal S12 a multiple of the Horizontal synchronization (HSYNC) signal. In addition, the timing signal S6 could be the frequency dividing signals S13 ‥ S14 with respect to the Horizontal synchronization (HSYNC) signal. The frequency of the frequency dividing signals S13 has a frequency value of ½ of the HSYNC signal. The frequency of the frequency dividing signals S13 has a frequency value of 1/N of the HSYNC signal, wherein N is greater than 0. Besides, the timing signal S6 also could be the vertical synchronization (VSYNC) signal S15, the frequency doubling signal S16 with respect to the vertical synchronization (VSYNC) signal, the frequency tripling signal S17 with respect to the vertical synchronization (VSYNC) signals, the frequency signal S18 multiple of the vertical synchronization (VSYNC) signal, or the frequency dividing signals S19 ‥ S20 with respect to the vertical synchronization (VSYNC) signal. The frequency of the frequency dividing signals S19 has a frequency value of ½ of the VSYNC signal. The frequency of the frequency dividing signals S20 has a frequency value of 1/N of the VSYNC signal, wherein N is greater than 0.

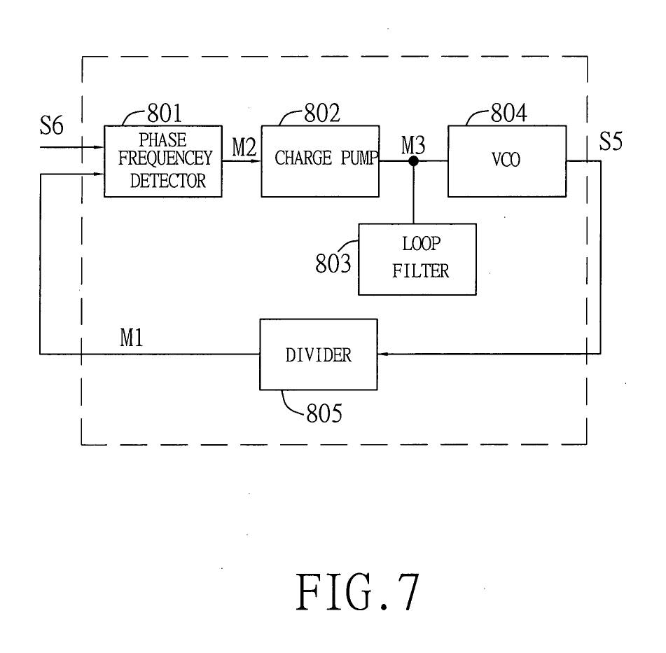

Referring to FIG. 7 of the drawings, a circuit diagram of a synchronous oscillator 431 according to the above preferred embodiment of the present invention is illustrated. A phase frequency detector 801 receives timing signal S6 and frequency dividing signals M1, which are generated by a divider 805, and compare their frequencies and phases to generate an error signal M2. The charge pump circuit 802 receives the error signal M2 to generate a voltage M3 which is filtered by a loop filter 803. A voltage-controlled oscillator 804 receives the voltage M3 to generate synchronous control signals S5.

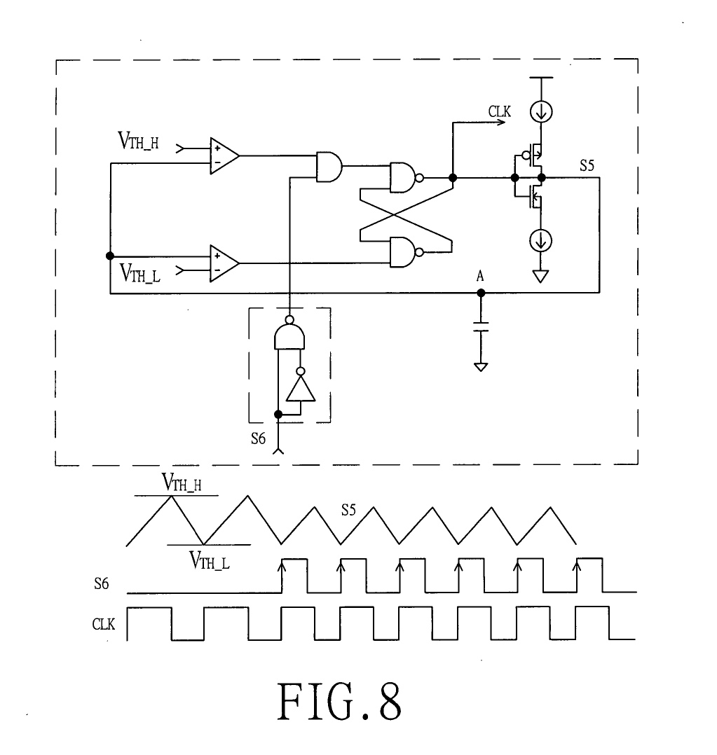

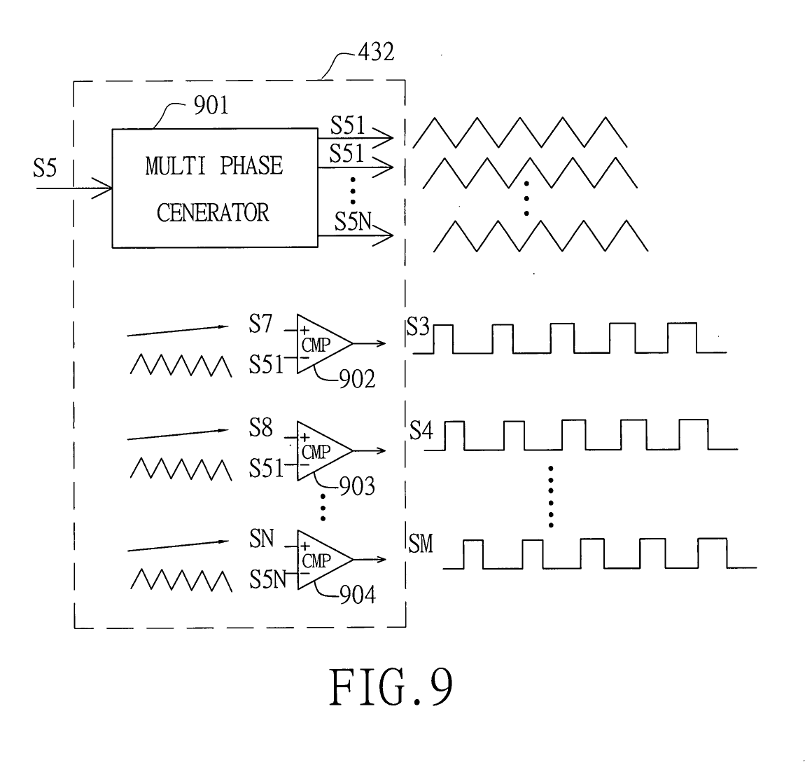

Referring to FIG. 8 of the drawings, an alternative circuit diagram of a synchronous oscillator 431 according to the above preferred embodiment of the present invention is illustrated.

Referring to FIG. 9 of the drawings, a circuit diagram of a multi phase PWM generator 432 according to the above preferred embodiment of the present invention is illustrated. A multi phase generator 901 which may be composed by a direct digital synthesizer (DDS) receives synchronous control signals S5 to generate several saw tooth ramps S51 ‥ S52 . . . S5N. Then comparators 902 ‥ 903 ‥ 904 compare signal S51 ‥ S7, and S52 ‥ S8, and S5N ‥ SN to generator PWM signals S3 ‥ S4 and SM respectively.

From the forgoing descriptions, it can be shown that the above objects have been substantially achieved. The present invention effectively provides an effective and flexible means of converting digital signal into an analog signal in a resources and cost-effective manner.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A controller for controlling at least two power circuits, comprising:
a synchronous oscillator receiving a timing signal for generating a synchronous control signal which is synchronous to said timing signal, wherein said timing signal is substantially synchronous to a display signal; and
a multi-phase PWM controller receiving said synchronous control signal for generating at least two PWM signals, wherein said at least two PWM signals are coupled to said at least two power circuits for driving said at least two power circuits respectively and said at least two PWM signals are synchronous to said display signal and with a phase shift between said at least two PWM signals.

2. The controller, as recited in claim 1, wherein said display signal is selected from a group consisting of a Horizontal synchronization signal, a frequency doubling signal with respect to said Horizontal synchronization signal, a frequency multiple signal with respect to said Horizontal synchronization signal, a frequency dividing signal with respect to said Horizontal synchronization signal, an output control signal for a source driver, an output control signal for a source driver start pulse, and an output control signal for a gate driver shift clock.

3. The controller, as recited in claim 1, wherein said display signal is selected from a group consisting of a vertical synchronization (VSYNC) signal, a frequency doubling signals with respect to said vertical synchronization (VSYNC) signal, a frequency multiple signal with respect to said vertical synchronization (VSYNC) signal, and a frequency dividing signal with respect to said vertical synchronization (VSYNC) signal.

4. The controller, as recited in claim 1, wherein said multi-phase PWM controller comprises:
at least two feedback controller coupled to at least two output circuits respectively for generating at least two feedback control signals;
a multi-phase PWM generator coupled to said synchronous oscillator and said at least two feedback controller for generating at least two PWM signals.

5. The controller, as recited in claim 2, wherein said multi-phase PWM controller comprises:
at least two feedback controller coupled to at least two output circuits respectively for generating at least two feedback control signals; and
a multi-phase PWM generator coupled to said synchronous oscillator and said at least two feedback controller for generating at least two PWM signals.

6. The controller, as recited in claim 4, wherein said multi-phase PWM controller further comprises at least two output drivers which are coupled to said multi-phase PWM generator for providing at least two control signals to control switches on and off durations in said at least two power circuits.

7. The controller, as recited in claim 5, wherein said multi-phase PWM controller further comprises at least two output drivers which are coupled to said multi-phase PWM generator for providing at least two control signals to control switches on and off durations in said at least two power circuits.

8. An electrical circuit for supplying energy to a LCD device, comprising:
at least two power circuits for supplying energy to said LCD device; and
a controller for controlling at least two power circuits, comprising:
a synchronous oscillator receiving a timing signal from said LCD device for generating a synchronous control signal which is synchronous to said timing signal, wherein said timing signal is substantially synchronous to a display signal; and
a multi-phase PWM controller receiving said synchronous control signal for generating at least two PWM signals, wherein said at least two PWM signals are coupled to said at least two power circuits for driving said at least two power circuits respectively and said at least two PWM signals are synchronous to said display signal and with a phase shift between said at least two PWM signals.

9. The electrical circuit, as recited in claim 8, wherein said power circuit further comprises an output circuit for supplying energy.

10. The electrical circuit, as recited in claim 9, wherein said multi-phase PWM controller comprises:
at least two feedback controllers coupled to said at least two output circuits respectively for generating at least two feedback control signals;
a multi-phase PWM generator coupled to said synchronous oscillator and said at least two feedback controller for generating at least two PWM signals.

11. The electrical circuit, as recited in claim 8, wherein said power circuit is a DC/DC converter.

12. The electrical circuit, as recited in claim 10, wherein said power circuit is a DC/DC converter.

13. The electrical circuit, as recited in claim 11, wherein said DC/DC converter is a selected from a group consisting of a buck converter, a boost converter, a push-pull converter, a forward converter, a half-bridge converter, a full-bridge converter, and a flyback converter.

14. The electrical circuit, as recited in claim 12, wherein said DC/DC converter is a selected from a group consisting of a buck converter, a boost converter, a push-pull converter, a forward converter, a half-bridge converter, a full-bridge converter, and a flyback converter.

15. A display device, comprising:
a display panel;
a driving circuit for driving said liquid crystal display panel;
at least two power circuits for providing energy to said display device; and
a controller for controlling at least two power circuits, comprising:
a synchronous oscillator receiving a timing signal from said source driver for generating a synchronous control signal which is synchronous to said timing signal, wherein said timing signal is substantially synchronous to a Horizontal synchronization signal; and
a multi-phase PWM controller receiving said synchronous control signal for generating at least two PWM signals, wherein said at least two PWM signals are coupled to said at least two power circuits for driving said at least two power circuits respectively and said at least two PWM signals are synchronous to said timing signal and with equal phase shift between said at least two PWM signals.

16. The display device, as recited in claim 15, wherein said display device is selected from a group consisting of a liquid crystal display monitor, a liquid crystal display television, and a liquid crystal display computer.

17. The display device, as recited in claim 16, wherein said power circuit is a DC/DC converter, wherein said DC/DC converter is a selected from a group consisting of a buck converter, a boost converter, a push-pull converter, a forward converter, a half-bridge converter, a full-bridge converter, and a flyback converter.

18. The display device, as recited in claim 15, wherein said driving circuit is a selected from a group consisting of a source driver, a gate driver.

19. A method for supplying energy to a LCD device, comprising of the steps of:
(a) generating a timing signal from a LCD timing controller;
(b) generating a synchronous control signal which is synchronous to said timing signal, wherein said timing signal is substantially synchronous to a display signal; and
(c) generating a PWM signal based on said synchronous control signal so as to driving a power circuit, wherein said power circuit supplies energy to a LCD device and said PWM signal is synchronous to said display signal.

20. The method, as recited in claim 19, wherein said power circuit is a DC/DC converter.
